(19) United States
(12) Patent Application Publication
(10) Pub. No.: US 2022/0410777 A1
(43) Pub. Date: Dec. 29, 2022

(54) Method Of Welding Vehicle Recliner Mechanisms

(71) Applicant: Fisher & Company, Incorporated, St. Clair Shores, MI (US)

(72) Inventors: Ralph L. SCHMITZ, Clinton Township, MI (US); Sapan Mahendra POPTANI, Northville, MI (US); Christopher J. RYAN, Fraser, MI (US); Steven A. HESSELL, Shelby Township, MI (US); Vicki A. WOOD, St. Clair Shores, MI (US)

(73) Assignee: Fisher & Company, Incorporated, St. Clair Shores, MI (US)

(21) Appl. No.: 17/836,780

(22) Filed: Jun. 9, 2022

Related U.S. Application Data
(60) Provisional application No. 63/215,055, filed on Jun. 25, 2021.

(51) Int. Cl. B60N 2/68; B60N 2/235; B23K 26/24

(52) U.S. Cl. CPC B60N 2/682; B60N 2/2356; B23K 26/24; B60N 2205/50; B23K 2101/006

(57) ABSTRACT

A method of laser welding a recliner assembly includes positioning a first component of a vehicle seat recliner mechanism with respect to a second component of the vehicle seat recliner mechanism. The method further includes retaining a position of the first component and the second component. Retaining includes forming a plurality of tack welds between the first component and the second component. The method further includes fixing the first component to the second component. Fixing includes forming a finishing weld between the first component and the second component by laser welding the first component to the second component.

### CROSS-REFERENCE TO RELATED APPLICATIONS

This application claims the benefit of U.S. Provisional Application No. 63/215,055, filed on Jun. 25, 2021. The entire disclosure of the above application is incorporated herein by reference.

### FIELD

The present disclosure relates to vehicle seat recliner mechanisms and methods of welding vehicle seat recliner mechanisms.

### BACKGROUND

This section provides background information related to the present disclosure and is not necessarily prior art.

Vehicle seats often include a recliner mechanism that can rotate a seatback relative to a seat bottom. Some of such vehicle recliner mechanisms are challenging to manufacture and are subject to distortion during the manufacturing process. The present disclosure provides a recliner mechanism and methods of manufacturing the recliner mechanism that reduces distortion and improves weld quality.

### SUMMARY

This section provides a general summary of the disclosure and is not a comprehensive disclosure of its full scope or all of its features.

In one form, the present disclosure provides a method of laser welding a vehicle seat recliner assembly. The method includes positioning a first component of a vehicle seat recliner mechanism with respect to a second component of the vehicle seat recliner mechanism. The method further includes retaining a position of the first component and the second component by forming a plurality of tack welds between the first component and the second component. The method further includes fixing the first component to the second component. The fixing includes forming a finishing weld between the first component and the second component by laser welding the first component to the second component.

In some configurations, the first component and the second component are selected from the group consisting of: an upper bracket plate, a lower bracket plate, a recliner heart, an encapsulating ring, a gear plate, a guide plate, a spring bracket, a stop bracket, or any combination thereof.

In some configurations, the first component includes the upper bracket plate, and the second component includes the recliner heart.

In some configurations, the first component includes the lower bracket plate, and the second component includes the recliner heart.

In some configurations, the first component includes the guide plate, and the second component includes the encapsulating ring.

In some configurations, the method further includes clamping the first component and the second component to a fixture before the retaining. The method further includes unclamping the first component and the second component from the fixture before the fixing.

In some configurations, the method further includes cooling a region including at least a portion of the finishing weld by directing a fluid at the region, the cooling being performed concurrently with the fixing.

In some configurations, the positioning and the retaining are performed at a first location and the fixing is performed at a second location. The method further comprises moving the first component and the second component from the first location to the second location after the retaining.

In some configurations, the positioning, the retaining, and the fixing are performed at the same location.

In some configurations, the plurality of tack welds include substantially equally spaced apart tack welds or substantially unequally spaced apart tack welds.

In some configurations, the tack welds include rim welds, lap welds or both rim and lap welds.

In some configurations, the finishing weld include a rim weld, a lap weld, or both rim and lap welds.

In some configurations, forming the plurality of tack welds includes laser welding.

In some configurations, forming the tack welds generates less heat than forming the finishing weld.

In some configurations, forming the tack welds uses a lower power than forming the finishing weld.

In some configurations, forming the tack welds includes applying power for about 0.5 seconds per tack weld.

In some configurations, forming the plurality of tack welds and forming the finishing weld is at a speed ranging from about 2 m/min to about 10 m/min.

In some configurations, the tack welds and finishing welds have a depth of fusion ranging from about 0.25 mm to about 3 mm and a width of fusion ranging from about 0.5 mm to 4.5 mm.

In another form, the present disclosure provides a method of laser welding a vehicle seat recliner assembly. The method includes positioning a first component of a vehicle seat recliner mechanism with respect to a second component of the vehicle seat recliner mechanism. The method further includes clamping the first component and the second component to a fixture. The method further includes retaining a position of the first component and the second component by forming a plurality of tack welds between the first component and the second component. The method further includes unclamping the first component and the second component from the fixture. The method further includes moving the first component and the second component from a first location to a second location. The method further includes fixing the first component to the second component. The fixing includes forming a finishing weld between the first component and the second component by laser welding the first component to the second component.

In some configurations, the first component and the second component are selected from the group consisting of: an upper bracket plate, a lower bracket plate, a recliner heart, an encapsulating ring, a gear plate, a guide plate, a spring bracket, a stop bracket, or any combination thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a side view of a vehicle seat assembly having a seat recliner assembly according to the principles of the present disclosure;

FIG. 2 is a perspective view of the seat recliner assembly of FIG. 1 having a pair of recliner mechanisms according to the principles of the present disclosure;

FIG. 3 is an exploded view of the recliner mechanism of FIG. 2;

FIG. 4 is another exploded view of the recliner mechanism of FIG. 2;

FIG. 5 is a perspective view of the recliner mechanism of FIG. 2;

FIG. 6 is another perspective view of the recliner mechanism of FIG. 2;

FIG. 7 is a side view of the recliner mechanism of FIG. 2;

FIG. 8 is a flowchart depicting a method of manufacturing the seat recliner assembly of FIG. 1 according to the principles of the present disclosure;

FIGS. 9A-9B relate to different types of tack welds and finishing welds applied to a recliner mechanism having a first and second recliner component according to the principles of the present disclosure; FIG. 9A is a partial sectional view showing the first and second recliner components joined by rim welds; and FIG. 9B is a partial sectional view showing the first and second recliner components joined by lap welds;

FIG. 10 is a side view of a recliner heart including tack welds between an encapsulating ring and a plate according to the principles of the present disclosure;

FIG. 11 is a partial sectional view of the exemplary recliner heart of FIG. 10 depicting a tack weld;

FIG. 12 is a side view of a recliner mechanism including tack welds between an upper bracket plate and a recliner heart according to the principles of the present disclosure;

FIG. 13 is a side view of a recliner mechanism including tack welds between a lower bracket and a recliner heart according to the principles of the present disclosure;

FIG. 14 is a side view of a recliner heart including finishing welds between an encapsulating ring and a plate according to the principles of the present disclosure;

FIG. 15 is a partial sectional view of the recliner heart of FIG. 14 depicting a finishing weld;

FIG. 16 is a side view of a recliner mechanism including finishing welds between an upper bracket plate and a recliner heart according to the principles of the present disclosure;

FIG. 17 is a partial sectional view of the recliner mechanism of FIG. 16 depicting a finishing weld;

FIG. 18 is a partial side view of a recliner mechanism including finishing welds according to the principles of the present disclosure;

FIG. 19 is a partial side view of the recliner mechanism of FIG. 18 including a finishing weld between an upper bracket plate and a stop bracket;

FIG. 20 is a partial sectional view of the recliner mechanism of FIG. 18 depicting the finishing weld between the upper bracket plate and the stop bracket;

FIG. 21 is a partial schematic view of the recliner mechanism of FIG. 18 depicting a weld pattern of the finishing weld;

FIG. 22 is a partial sectional view of the recliner mechanism of FIG. 18 depicting a finishing weld between a lower bracket plate and a spring bracket;

FIG. 23 is a partial sectional view of the recliner mechanism of FIG. 18 depicting a finishing weld between the lower bracket plate and a recliner heart; and

FIG. 24 is a photograph of a recliner mechanism prepared according to the principles of the present disclosure depicting a finishing weld between an upper bracket and a recliner heart;

FIG. 25 is a photograph of the recliner mechanism of FIG. 24 depicting the finishing weld between the upper bracket and the recliner heart;

FIG. 26 is a photograph of the recliner mechanism of FIG. 24 depicting the finishing weld between the upper bracket and the recliner heart;

FIG. 27 is a photograph of the recliner mechanism of FIG. 24 depicting the finishing weld between the upper bracket and the recliner heart; and

FIG. 28 is a photograph of the recliner mechanism of FIG. 24, depicting a finishing weld between the upper bracket and the recliner heart and another finishing weld between the upper bracket and a stop bracket.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

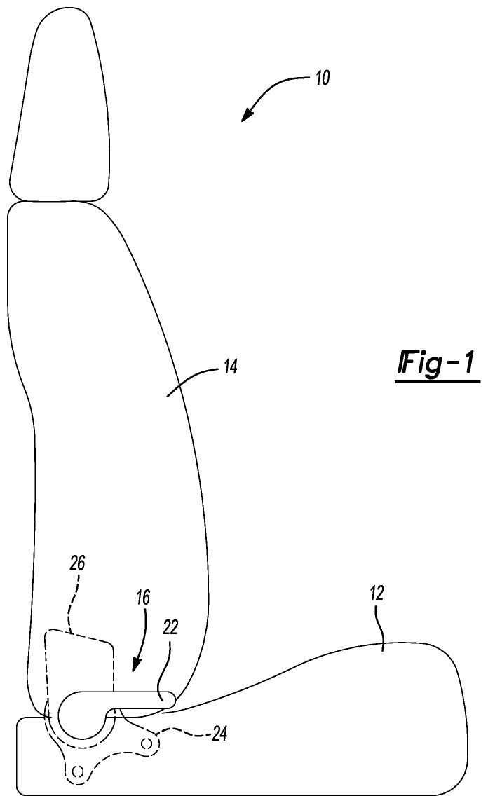

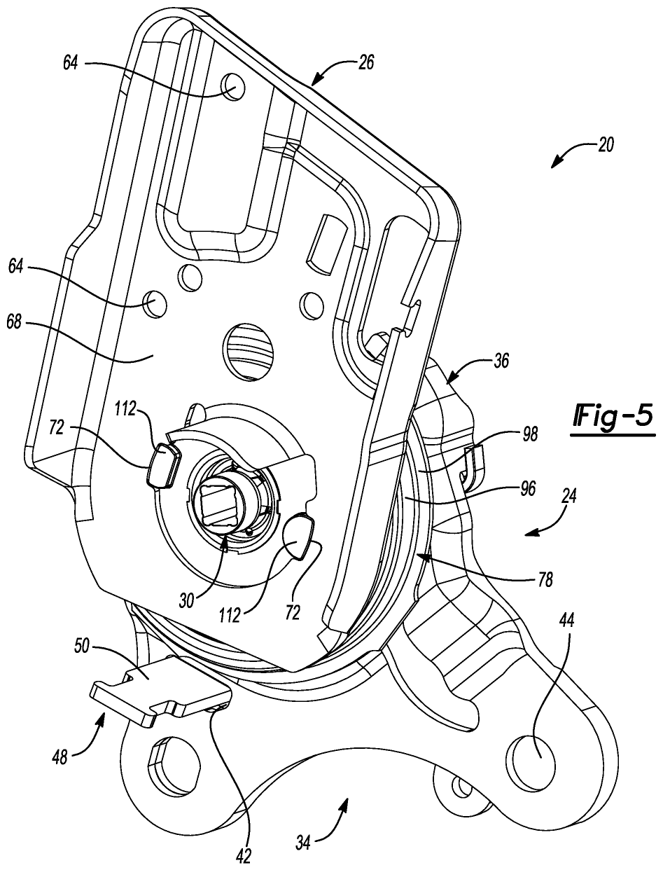

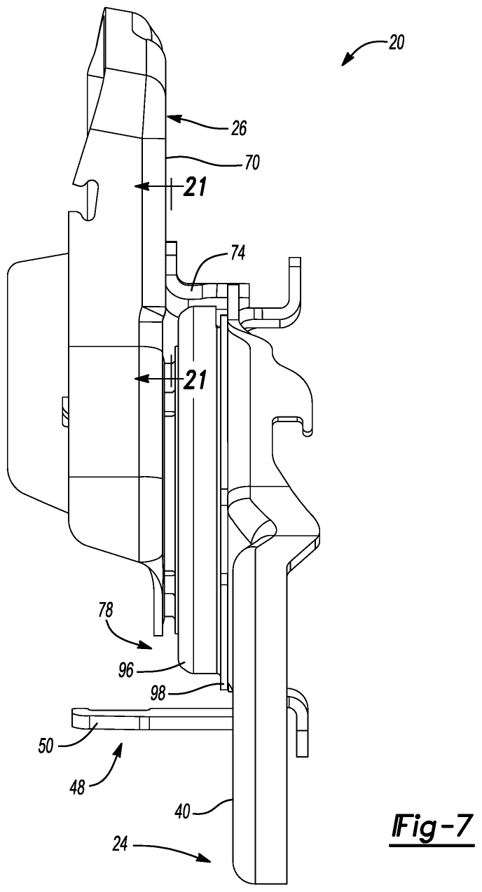

With reference to FIGS. 1-7, a vehicle seat assembly 10 is shown (FIG. 1). The vehicle seat assembly 10 may be positioned within a vehicle (not shown) and may include a seat bottom 12, a seatback 14, and a seat recliner assembly 16. The seat recliner assembly 16 is connected to the seat bottom 12 and the seatback 14 and can be actuated to allow movement of the seatback 14 relative to the seat bottom 12 among a range of positions including an upright position (FIG. 1), a rearward reclined position (not shown), and a forward dump position (not shown). The seat recliner assembly 16 may be a recliner mechanism as described in U.S. Pat. No. 10,864,830 to Schmitz et al., issued Dec. 15, 2020, the entire contents of which is incorporated herein by this reference hereto.

The seat recliner assembly 16 may include a cross member 18, a pair of recliner mechanisms 20, and a hand lever 22 connected to the recliner mechanism 20. Each of the recliner mechanisms 20 may be disposed at opposing ends of the cross member 18. The hand lever 22 may be attached to either of the recliner mechanisms 20. In some embodiments, the hand lever 22 may be attached to the recliner mechanism 20 that is positioned outboard in the vehicle.

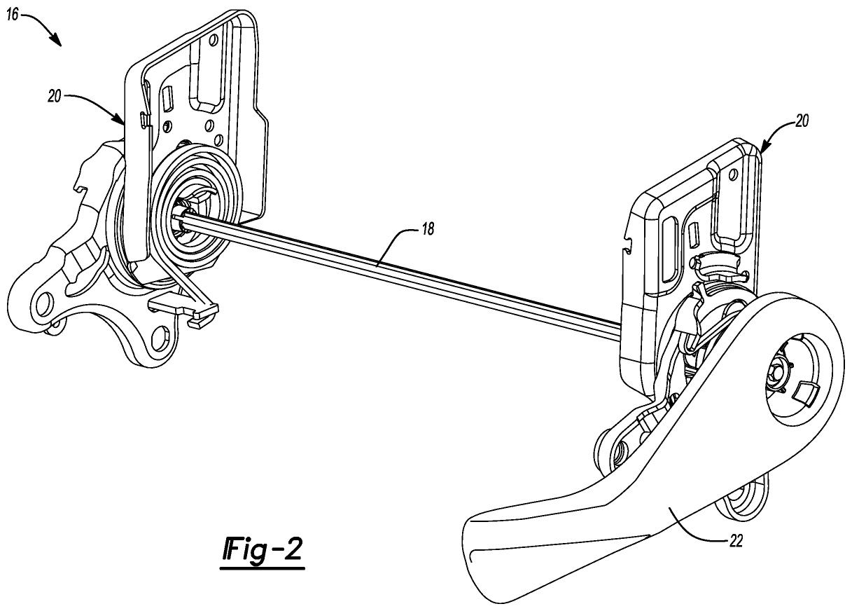

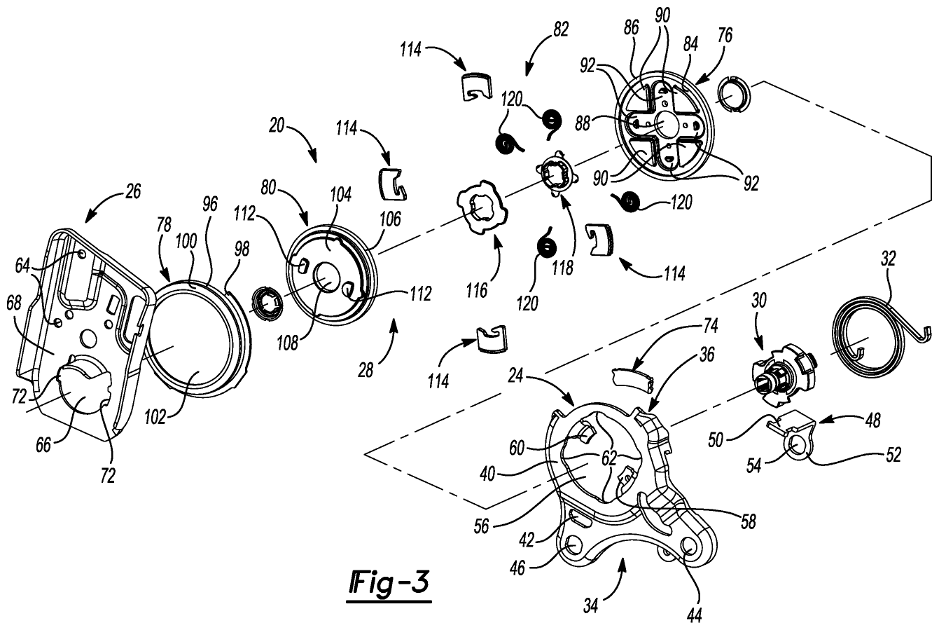

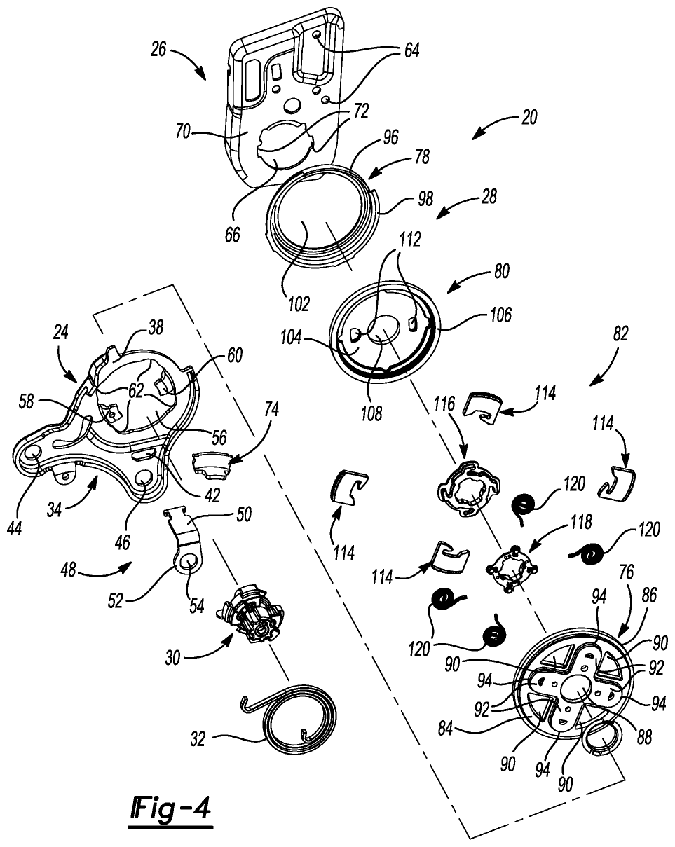

With reference to FIGS. 2-7, the recliner mechanism 20 may include a first bracket plate 24 (or lower bracket plate or housing plate), a second bracket plate 26 (or upper bracket plate), a recliner heart 28 (FIGS. 3-4), a hub 30, and a torsion spring 32 (FIGS. 3-6). The first and second bracket plates 24, 26 are mounted to the recliner heart 28. The first bracket plate 24 may be fixedly mounted to the seat bottom 12 (FIG. 1) and include a first portion 34 and a second portion 36. More specifically, the first bracket plate 24 includes a first surface 38 facing the hand lever 22 (FIGS. 1-2) and a second surface 40 mounted to the recliner heart 28. The first portion 34 may include a slot 42 and a plurality of apertures 44, 46 formed therein. A tab 48 (or spring bracket) may extend through the slot 42 formed in the first portion 34 and may include a first member 50 and a second member 52 extending perpendicularly from the first member 50. The first member 50 extends through the slot 42 and limits or restricts the rotation of the seatback 14 (FIG. 1) in the rearward reclined position and the forward dump position. The second member 52 may include an aperture 54 that aligns with the aperture 46 of the first portion 34 once the first member 50 extends through the slot 42. A first fastener (not shown) may extend through the aperture 44 to securely attach the first bracket plate 24 to the seat bottom 12 and a second fastener (not shown) may extend through the apertures 46, 54 to securely attach the first bracket plate 24 and the tab 48 to the seat bottom 12.

The second portion 36 may be substantially circular and define an opening 56 in a central portion thereof. The second portion 36 may include first and second flanges 58, 60 (FIGS. 3-4) and a plurality of grooves 62 (FIGS. 3-4 and 6). The first and second flanges 58, 60 may extend perpendicularly from a periphery of the opening 56 toward each other. The plurality of grooves 62 may be formed in the second portion 36 at or near the periphery of the opening 56.

The second bracket plate 26 may be generally rectangular and may include a plurality of apertures 64 (FIGS. 3-6) and a central aperture 66 (FIGS. 3-4) through which the cross member 18 (FIG. 2) extends. The second bracket plate 26 includes a first surface 68 facing the cross member 18 (FIG. 2) and a second surface 70 mounted to the recliner heart 28. Fasteners (not shown) may extend through the plurality of apertures 64 to securely attach the second bracket plate 26 the seatback 14 (FIG. 1). One or more grooves 72 may be formed at the or near the periphery of the central aperture 66. In some embodiments, two grooves 72 may be disposed at diametrically opposed positions of the central aperture 66. A stop bracket 74 may be coupled to the second bracket plate 26.

The recliner heart 28 may be mounted to the first and second bracket plates 24, 26 and may be operable in an unlocked state permitting relative rotation between the seatback 14 and the seat bottom 12 (FIG. 1) and a locked state preventing relative rotation between the seatback 14 and the seat bottom 12. The recliner heart 28 may be a round recliner heart, for example, or any other suitable type of recliner heart. The recliner heart 28 may include a first plate 76 (or guide plate), an encapsulating ring 78, a second plate 80 (or gear plate or ratchet plate), and a locking mechanism 82.

The first plate 76 may be rotationally fixed relative to the seat bottom 12 and may be attached to the encapsulating ring 78. The first plate 76 may include a plate surface 84 and a rim 86. The plate surface 84 may include an aperture 88, a plurality of triangular-shaped bosses 90 and a plurality of mounting members 92 having mounting ends 94. The aperture 88 may extend through a center portion of the plate surface 84. The plurality of bosses 90 may be disposed radially around the aperture 88 and may extend from the plate surface 84, thereby defining a recess. Each recess may be disposed between two of the plurality of bosses 90.

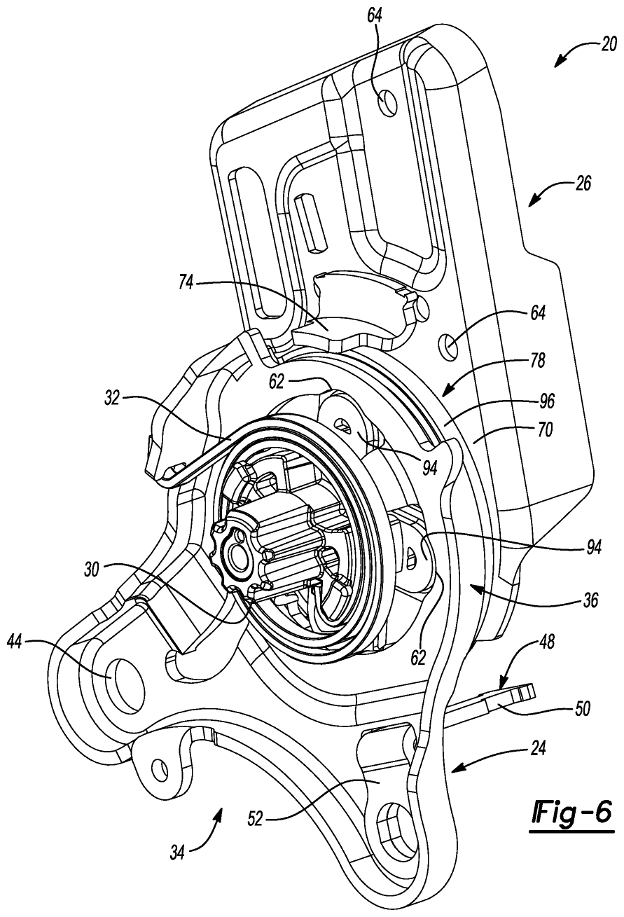

The plurality of mounting members 92 may extend from the plate surface 84 opposite the direction of the bosses 90. The mounting members 92 may extend from the plate surface 84 such that each mounting end 94 is configured to be mounted into a corresponding groove 62 of the first bracket plate 24 (FIG. 6). The rim 86 may extend 360 degrees around a periphery of the plate surface 84 and may be attached to the encapsulating ring 78.

The encapsulating ring 78 may include a body 96 and a first and second flanges 98, 100. The first flange 98 may extend radially outwardly from an axial end of the body 96 and may also extend at least partially around the body 96 (e.g., between 180 degrees and 360 degrees). The second flange 100 may extend radially inwardly from another axial end of the body 96 to define an opening 102 and may also extend 360 degrees around the body 96.

The second plate 80 may be rotationally fixed to the seatback 14 and may be a generally round, flat disk. The second plate 80 may include a plate surface 104 and a rim 106. The plate surface 104 may include an aperture 108 extending through a center portion thereof and a plurality of projections 112 extending from the plate surface 104 opposite the direction of the rim 106. The plurality of projections 112 may be received in the grooves 72 of the second bracket plate 26 once the recliner heart 28 is mounted to the second bracket plate 26.

In some embodiments, the locking mechanism 82 may include a plurality of pawls 114, a cam 116, a connector disk 118, and a plurality of spring coils 120. Collectively, the locking mechanism 82 is operable to move between a locked state and an unlocked state in response to a user's input from hand lever 22 (FIG. 1) using the plurality of pawls 114, the cam 116, the connector disk 118, and the plurality of spring coils 120.

The process of forming the recliner mechanisms by laser welding may be complex and/or challenging. First, the laser welding process generates a significant amount of smoke. The presence of smoke in a welding region may impede the laser beam and therefore cause reduced or uneven heating of the metal. Accordingly, the presence of significant amounts of smoke may decrease weld strength compared to a weld formed with less smoke.

Second, the laser welding process may generate a significant amount of heat. Internal stresses caused by heating and/or subsequent cooling may cause deformation of the recliner components. Moreover, type and amount of distortion may vary between different components. Accordingly, gaps, which may have inconsistent dimensions across the assembly, may be created between components. The gaps may cause a reduction in weld strength compared to an assembly that is free of gaps, has smaller gaps, or has dimensionally-consistent gaps. Additionally, the high heat may result in weld spatter on the components and/or fixture, which may necessitate frequent cleaning.

A fluid, such as air, may be directed toward and/or circulated around the weld region to reduce or remove smoke from the region and/or to cool the components and reduce deformation. Additionally, the recliner components may be tightly clamped to one another and/or a fixture to reduce deformation. However, the size, quantity, and position of clamps may interrupt flow of the fluid, which may reduce or eliminate the fluid's smoke removal and/or cooling effects.

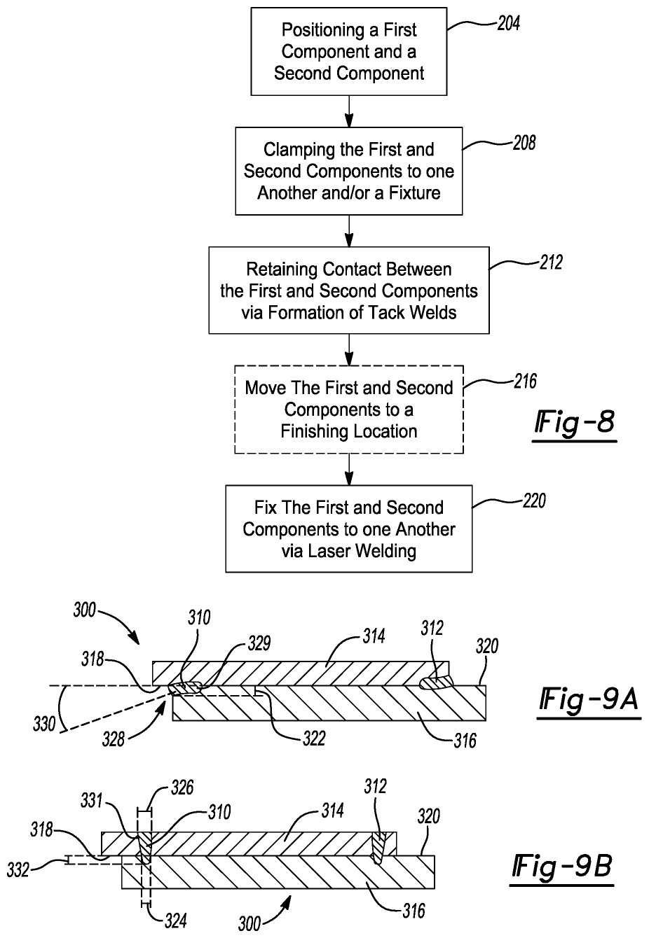

With reference to FIG. 8-23, a method of manufacturing a recliner mechanism or a portion of the recliner mechanism is provided according to the principles of the present disclosure. For purposes of simplicity, a first bracket plate, second bracket plate, recliner heart, tab, and stop bracket are collectively referred to as recliner components. The recliner components may be assembled via a laser welding process.

The method of manufacturing a recliner mechanism includes forming preliminary or tack welds prior to forming finishing welds. The tack welds may hold the components in an aligned position to reduce or eliminate the need for large, high-strength clamps. Accordingly, the fluid may be directed toward the weld region during formation of the finishing weld to effectively cool the components and reduce or eliminate smoke. The reduction in heat may facilitate a reduction in deformation and improved accuracy of component location. The finishing welds have a higher strength than welds formed without first forming tack welds due to the reduction in smoke, reduced deformation, and accurate component locating. In some examples, the tack welds and finishing welds may be formed at different stations, reducing the complexity of the finishing weld station because it not needed to locate the components concurrently with welding.

With reference to FIG. 8, a method of manufacturing a recliner mechanism according to the principles of the present disclosure is provided. At 204, the method includes positioning a first component and a second component. At 208, the method includes clamping the first and second components to another and/or to a fixture. At 212, the method includes retaining contact between the first and second components via formation of tack welds. At 216, the method includes moving the first and second components to a finishing location. At 220, the method includes fixing the first and second components to one another via formation of a finishing weld (i.e., by laser welding).

With additional reference to FIGS. 9A-9B, the method of manufacturing a recliner mechanism 300 or a portion of the recliner mechanism 300 using a tack weld 310 and a finishing weld 312 will now be described in greater detail. The method is described in relation to the recliner mechanism 300. In one example, the recliner mechanism may be the recliner mechanism 20 of FIGS. 1-7. However, as would be appreciated by a person skilled in the art, the method applies equally to other recliner mechanisms.

At 204, the method includes positioning a first recliner component 314 of the recliner mechanism 300 with respect to a second recliner component 316 of the recliner mechanism 300. The first and second recliner components 314, 316 may be independently selected from the recliner components or another component of the recliner mechanism (e.g., the recliner mechanism 20 of FIGS. 1-7). Positioning may include placing a surface 318 (FIG. 9A-9B) of the first recliner component 314 in direct physical contact with a surface 320 (FIG. 9A-9B) of the second recliner component 316. Positioning may also include locating the first and/or second recliner component 314, 316 with respect to the other of the first and/or second recliner component 314, 316 according to a predetermined assembly specification. For example and with reference to FIGS. 3-7, a first recliner component may include the first plate 76 and a second recliner component may include the first bracket plate 24. The plate surface 84 of the first plate 76 may be positioned to contact the second surface 40 of the first bracket plate 24. Additionally, the mounting members 92 of the first plate 76 may be located to align with the grooves 62 of the first bracket plate 24. Positioning may be performed in a fixture or jig.

Returning to FIGS. 8-9B, at 208, the method may further include clamping the first and second recliner components 314, 316 to one another and/or a fixture. Due to relatively low heat generated during formation of tack welds 310 (e.g., due to low power used to form the tack welds 310 and/or shorter duration of applying power) and flexibility in size, shape, and arrangement of tack welds 310, the clamps may be positioned to best facilitate alignment. It is not necessary that the clamps leave clearance for fluid flow (e.g., for cooling and/or smoke removal) because the tack welds 310 are generally formed with a lower enough power and/or for a short enough duration of power application to avoid generation of a significant amount of heat and/or smoke.

At 212, the method includes retaining contact between the first and second recliner components 314, 316 via formation of the tack welds 310. In some example embodiments, the tack welds 310 are formed by laser welding. In other example embodiments, the tack welds 310 are formed by other types of welding, such as resistance welding.

Formation of the tack welds 310 does not generate significant heat, smoke, or weld spatter (leaving the fixture, clamps, and/or components substantially clean). In some example embodiments, the tack welds 310 may generally be formed using a lower power than the finishing welds 312. In some example embodiments, the tack welds 310 may be formed using a power of less than or equal to about 5 kW (e.g., less than or equal to about 4.5 kW, less than or equal to about 4 kW, less than or equal to about 3.5 kW, less than or equal to about 3 kW, less than or equal to about 2.5 kW). The tack welds 310 may be formed using a power of greater than or equal to about 2 kW (e.g., greater than or equal to about 2.5 kW, greater than or equal to about 3 kW, greater than or equal to about 3.5 kW, greater than or equal to about 4 kW, or greater than or equal to about 4.5 kW). For example, the power may range from about 2.5 kW to about 5 kW (e.g., about 2.7 kW to about 2.9 kW, about 3.4 kW to about 3.6 kW, or about 4.7 kW to about 4.9 kW). Moreover, power is only applied for about 0.5 seconds per tack weld 310.

In at least some example embodiments, the tack welds 310 may be formed at a speed of greater than or equal to about 2 m/min (e.g., greater than or equal to about 3 m/min, greater than or equal to about 4 m/min, greater than or equal to about 5 m/min, greater than or equal to about 6 m/min, greater than or equal to about 7 m/min, greater than or equal to about 8 m/min, greater than or equal to about 9 m/min). The speed may be less than or equal to about 10 m/min (e.g., less than or equal to about 9 m/min, less than or equal to about 8 m/min, less than or equal to about 7 m/min, less than or equal to about 6 m/min, less than or equal to about 5 m/min, less than or equal to about 4 m/min, or less than or equal to about 3 m/min).

The tack welds 310 may be achieved using a straight beam. In at least some example embodiments, the tack welds 310 may be formed with a laser focal length ranging from about 200 mm to about 1 m (e.g., 200 mm to 300 mm, 300 mm to 400 mm, 400 mm to 500 mm, 500 mm to 600 mm, 600 mm to 700 mm, 700 mm to 800 mm, 800 mm to 900 mm, or 900 mm to 1 m). In at least some example embodiments, the tack welds 310 may be formed with a fiber size ranging from about 150 microns to about 350 microns (e.g., 150 microns to 175 microns, 175 microns to 200 microns, 200 microns to 225 microns, 225 microns to 250 microns, 250 microns to 275 microns, 275 microns to 300 microns, 300 microns to 325 microns, or 325 microns to 350 microns).

The tack weld 310 retains a portion of the first recliner component 314 to a portion of the second recliner component 316. The tack weld 310 may have a depth of fusion 322 (FIGS. 9A-9B) and a width of fusion 324 (FIG. 9B). The depth of fusion 322 may be greater than or equal to about 0.25 mm (e.g., greater than or equal to about 0.5 mm, greater than or equal to about 1 mm, greater than or equal to about 1.5 mm, greater than or equal to about 2 mm, or greater than or equal to about 2.5 mm). The depth of fusion 322 may be less than or equal to about 3 mm (e.g., less than or equal to about 2.5 mm, less than or equal to about 2 mm, less than or equal to about 1.5 mm, less than or equal to about 1 mm, or less than or equal to about 0.5 mm). The width of fusion 324 may be greater than or equal to about 0.5 mm (e.g., greater than or equal to about 1 mm, greater than or equal to about 1.5 mm, greater than or equal to about 2 mm, or greater than or equal to about 2.5 mm). The width of fusion 324 may be less than or equal to about 4.5 mm (e.g., less than or equal to about 3.5 mm, less than or equal to about 2.5 mm, less than or equal to about 2 mm, less than or equal to about 1.5 mm, or less than or equal to about 1 mm).

The plurality of tack welds 310 may include greater than or equal to 2 tack welds (e.g., greater than or equal to 3 tack welds, greater than or equal to 4 tack welds, greater than or equal to 5 tack welds, greater than or equal to 6 tack welds, greater than or equal to 7 tack welds, greater than or equal to 8 tack welds, greater than or equal to 9 tack welds, greater than or equal to 10 tack welds, greater than or equal to 12 tack welds, greater than or equal to 15 tack welds, or greater than or equal to 20 tack welds). A quantity of tack welds 310 may be dependent upon part size, shape, and complexity.

The tack welds 310 may be applied in a sequence when greater than 2 tack welds are provided. In some examples where the tack welds 310 are provided about a substantially circular surface, the sequence of applying the tack welds 310 may take a non-circular path. For example, when 6 tack welds 310 are provided about the substantially circular surface at 0°, 60°, 120°, 180°, 240°, 300° positions, the tack welds may be applied first at the 0° position, then at the 180° position, then at the 60° position, then at the 240° position, then at the 120° position, and lastly at the 300° position. In some embodiments, the tack welds 310 may be substantially evenly spaced apart from one another and symmetrically positioned (e.g., at 30°, 90°, 150°, 210°, 270°, and 330°). In other embodiments, the tack welds 310 may be unequally spaced and asymmetrically positioned to suit the component geometry (e.g., 45°, 105°, 150°, 180°, 225°, 255° and 285°).

Each of the tack welds 310 of the plurality may have substantially the same shape. Alternatively, the tack welds 310 may have different shapes to suit the component geometry. Some examples of tack weld shapes include circular, linear, rectangular, and the like. The tack welds 310 may define a dimension 326 (FIG. 9B), such as a diameter, greater than or equal to about 0.5 mm (e.g., greater than or equal to about 1 mm, greater than or equal to about 1.5 mm, greater than or equal to about 2 mm, greater than or equal to about 2.5 mm, greater than or equal to about 3 mm, greater than or equal to about 3.5 mm, greater than or equal to about 4 mm). The dimension 326 may be less than or equal to about 5 mm (e.g., less than or equal to about 4.5 mm, less than or equal to about 4 mm, less than or equal to about 3.5 mm, less than or equal to about 3 mm, less than or equal to about 2.5 mm, or less than or equal to about 2 mm). For example, the dimension 326 may range from about 1 mm to about 4 mm (e.g., about 2 mm to about 3 mm).

As shown in FIGS. 9A-9B, the plurality of tack welds 310 may include rim welds, lap welds, or a combination of rim welds and lap welds. With reference to FIG. 9A, the first recliner component 314 and the second recliner component 316 are retained in position by the tack weld 310 including a rim weld 329 according to the principles of the present disclosure. The rim weld 329 is provided when a laser beam (not shown) is positioned at a joint 328 between the first and second recliner components 314, 316. More specifically, the laser beam may be positioned at a laser beam angle 330 greater than or equal to about 2 degrees (e.g., greater than or equal to about 3 degrees, greater than or equal to about 4 degrees, greater than or equal to about 5 degrees, greater than or equal to about 6 degrees, greater than or equal to about 7 degrees, greater than or equal to about 8 degrees, greater than or equal to about 9 degrees, greater than or equal to about 10 degrees, greater than or equal to about 11 degrees, greater than or equal to about 12 degrees, greater than or equal to about 13 degrees, greater than or equal to about 14 degrees, or greater than or equal to about 15 degrees). The laser beam angle 330 may be less than or equal to about 16 degrees (e.g., less than or equal to about 15 degrees, less than or equal to about 14 degrees, less than or equal to about 13 degrees, less than or equal to about 12 degrees, less than or equal to about 11 degrees, less than or equal to about 10 degrees, less than or equal to about 9 degrees, less than or equal to about 8 degrees, less than or equal to about 7 degrees, less than or equal to about 6 degrees, less than or equal to about 5 degrees, less than or equal to about 4 degrees, or less than or equal to about 13 degrees).

Referring to FIG. 9B, the first recliner component 314 and the second recliner component 316 are retained in position by the tack weld 310 including a lap weld 331 according to the principles of the present disclosure. The lap weld 331 is provided when the laser beam is positioned substantially perpendicular to the first recliner component 314, and the lap weld 331 extends fully through the first recliner component 314 and partially through the second recliner component 316. The lap weld 331 may have a depth of weld root penetration 332 measured from the surface 320 of the second recliner component 316 to an end of the lap weld. The depth of weld root penetration 332 may be greater than or equal to about 0.5 mm (e.g., greater than or equal to about 1 mm, greater than or equal to about 1.5 mm, greater than or equal to about 2 mm, or greater than or equal to about 2.5 mm). The depth of weld root penetration 332 may be less than or equal to about 3 mm (e.g., less than or equal to about 2.5 mm, less than or equal to about 2 mm, less than or equal to about 1.5 mm, or less than or equal to about 1 mm).

A selection between using the rim weld, lap weld, or combination of rim welds and lap welds may be dependent on a number of parameters or criteria such as the thickness of the first and second recliner components 314, 316, the material properties of the first and second recliner components 314, 316, the strength required of the weld, the available access path to the welding location, and the like.

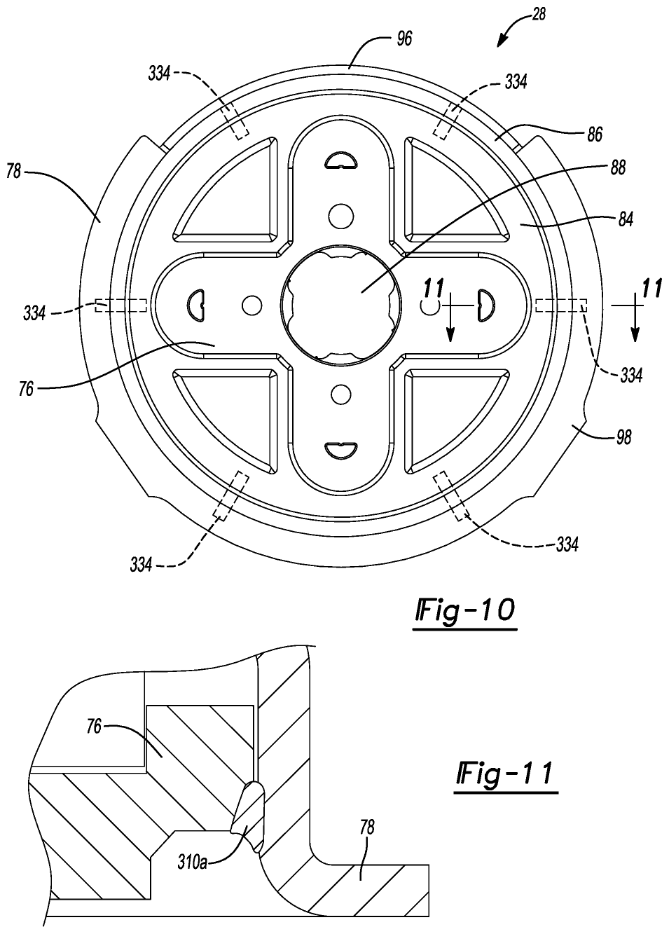

The first and second recliner components 314, 316 may be any of the recliner components listed above. In some example embodiments, the first recliner component 314 and the second recliner component 316 are components of the recliner heart 28 of FIGS. 1-7. In at least one example embodiment, the first recliner component 314 may be the encapsulating ring 78 and the second recliner component 316 may be the first plate 76. FIGS. 10-11 depict a plurality of tack welds 310a (which may be the same as tack welds 310 of FIG. 9A-9B) on the recliner heart 28 according to the principles of the present disclosure. More specifically, a plurality of tack weld regions 334 is provided. Each tack weld region 334 represents a region where the tack welds 310a may be positioned. The tack weld regions 334 extend at least between the body 96 of the encapsulating ring 78 and the rim 86 of the first plate 76. Some tack weld regions 334 may extend between the first flange 98 of the encapsulating ring 78 and the rim 86 of the first plate 76. Accordingly, the plurality of tack welds 310a are positioned between the encapsulating ring 78 and the first plate 76. The shown configuration provides the tack weld regions 334 spaced annularly about the aperture 88 at an approximately 30°, 90°, 150°, 210°, 270° and 330° location. Accordingly, the plurality of tack welds 310a may be positioned at an approximately 30°, 90°, 150°, 210°, 270° and 330° location. In other words, the tack welds 310a may be evenly spaced apart 60° from each other. Alternatively, the tack welds 310a may be unevenly spaced from each other, and may also be fewer or greater in quantity. The tack welds 310a may be rim welds, as depicted, or alternatively lap welds.

In at least some example embodiments, the first and second recliner components 314, 316 include the second bracket plate 26 and the recliner heart 28 of FIGS. 1-7 (e.g., a second plate 80 of the recliner heart 28). FIG. 12 depicts a plurality of tack welds 310b (which may be the same as tack welds 310 of FIG. 9A-9B) between the second bracket plate 26 and the second plate 80 according to the principles of the present disclosure. The tack welds 310b extend through the second bracket plate 26 and into the plate surface 104 of the second plate 80. Each of the tack welds 310b may be positioned within a plurality of tack weld regions (not shown). The shown configuration provides the tack welds 310b positioned at an approximately 0°, 60°, 120°, 180°, 240° and 300° location. In other words, the tack welds 310b may be evenly spaced apart 60° from each other. Alternatively, the tack welds 310b may be unevenly spaced from each other, and may also be fewer or greater in quantity. The tack welds 310b may be lap welds, as depicted, or alternatively rim welds.

In at least some example embodiments, the first and second recliner components 314, 316 include the first bracket plate 24 and the recliner heart 28 (e.g., the encapsulating ring 78 of the recliner heart) of FIGS. 1-7. FIG. 13 depicts a plurality of tack welds 310c (which may be the same as tack welds 310 of FIG. 9A-9B) between the first bracket plate 24 and the encapsulating ring 78 according to the principles of the present disclosure. The tack welds 310c extend through the first bracket plate 24 and into the first flange 98 (FIGS. 3-4) of the encapsulating ring 78. Each of the tack welds 310c may be positioned within a plurality of tack weld regions (not shown). The tack welds 310c may be positioned at an approximately 45°, 105°, 150°, 180°, 225°, 255° and 285° location. In other words, the tack welds 310c may be unevenly spaced apart from each other and asymmetrically positioned. Alternatively, the tack welds 310c may be evenly spaced from each other or symmetrically positioned, and also may be fewer or greater in quantity. The tack welds 310c may be lap welds, as depicted, or alternatively rim welds.

Returning to FIG. 8-9B, at 216, the method optionally includes moving the first and second recliner components 314, 316 to a finishing location. In some example embodiments, steps 212 and 220 are performed at different stations or locations, such as a tacking location and a finishing location. The tacking location may be used for formation of the lower power, lower heat, and/or lower spatter tack welds. Accordingly, fixtures or jigs that are used for alignment and/or position of the components may remain clean, resulting in high accuracy and/or infrequent need for cleaning. The finishing location may be used for formation of the higher power, higher heat, and/or higher spatter finishing weld. Because the components will already be positioned and/or aligned by the time they reach the finishing location, it is not necessary to have as intricate and/or clean fixtures at the finishing location as the tacking location.

In other example embodiments, steps 212 and 220 are performed at the same location or station. However, clamps used for tack welding at 212 may be removed prior to beginning laser welding of the finishing weld 312. When the tack welding includes laser welding, steps 212 and 220 may be performed with the same laser head.

At 220, the method includes fixing the first and second recliner components 314, 316 to one another by the finishing weld 312 via laser welding. The first and second recliner components 314, 316 may be any of recliner components listed above. The finishing weld 312 may be formed in a different region than the tack weld 310 (e.g., non-overlapping, overlapping but not coextensive). The finishing weld 312 may have the same depth of fusion 322 and width of fusion 324 as the tack welds 310. The finishing welds 312 may include the above-described rim welds, lap welds, or a combination of rim welds and lap welds.

Formation of the finishing weld 312 at 220 may generate greater heat than formation of the tack weld 310 at 212. In at least some example embodiments, the finishing weld 312 may be formed with a higher power than the tack welds 310. In at least some example embodiments, the finishing welds 312 are formed using a power of greater than or equal to about 2.5 kW (e.g., greater than or equal to about 3 kW, greater than or equal to about 3.1 kW, greater than or equal to about 3.2 kW, greater than or equal to about 3.3 kW, greater than or equal to about 3.4 kW, greater than or equal to about 3.5 kW, greater than or equal to about 3.6 kW, greater than or equal to about 3.7 kW, greater than or equal to about 3.8 kW, greater than or equal to about 3.9 kW, greater than or equal to about 4 kW, greater than or equal to about 4.1 kW, greater than or equal to about 4.2 kW, greater than or equal to about 4.3 kW, greater than or equal to about 4.4 kW, or greater than or equal to about 4.5 kW). The power may be less than about 5 kW (e.g., less than or equal to about 4.5 kW, less than or equal to about 4.4 kW, less than or equal to about 4.3 kW, less than or equal to about 4.2 kW, less than or equal to about 4.1 kW, less than or equal to about 4.0 kW, less than or equal to about 3.9 kW, less than or equal to about 3.8 kW, less than or equal to about 3.7 kW, less than or equal to about 3.6 kW, less than or equal to about 3.5 kW, less than or equal to about 3.4 kW, less than or equal to about 3.3 kW, less than or equal to about 3.2 kW, less than or equal to about 3.1 kW, or less than or equal to about 3.0 kW).

In at least some example embodiments, the finishing welds 312 may be formed at a speed of greater than or equal to about 2 m/min (e.g., greater than or equal to about 3 m/min, greater than or equal to about 4 m/min, greater than or equal to about 5 m/min, greater than or equal to about 6 m/min, greater than or equal to about 7 m/min, greater than or equal to about 8 m/min, greater than or equal to about 9 m/min). The speed may be less than or equal to about 10 m/min (e.g., less than or equal to about 9 m/min, less than or equal to about 8 m/min, less than or equal to about 7 m/min, less than or equal to about 6 m/min, less than or equal to about 5 m/min, less than or equal to about 4 m/min, or less than or equal to about 3 m/min). In at least some example embodiments, the finishing welds 312 may be formed with a laser focal length ranging from about 200 mm to about 1 m (e.g., 200 mm to 300 mm, 300 mm to 400 mm, 400 mm to 500 mm, 500 mm to 600 mm, 600 mm to 700 mm, 700 mm to 800 mm, 800 mm to 900 mm, or 900 mm to 1 m).

The finishing weld 312 may be in the form of a plurality of finishing welds or a single continuous finishing weld. The finishing weld 312 as a plurality may include greater than or equal to 2 finishing welds (e.g., greater than or equal to 3 tack welds, greater than or equal to 4 finishing welds, greater than or equal to 5 finishing welds, greater than or equal to 6 finishing welds, greater than or equal to 7 finishing welds, greater than or equal to 8 finishing welds, greater than or equal to 9 finishing welds, greater than or equal to 10 finishing welds, greater than or equal to 12 finishing welds, greater than or equal to 15 finishing welds, or greater than or equal to 20 finishing welds). The quantity of finishing welds 312 may be dependent upon part size, shape, and complexity. The finishing welds 312 as a plurality may be substantially evenly spaced apart from one another and symmetrically positioned or alternatively, unequally spaced and asymmetrically positioned to suit the component geometry.

Each of the finishing welds 312 of the plurality may have substantially the same shape. Alternatively, each finishing weld 312 may have different shapes to suit the component geometry. Some examples of finishing weld shapes include circular, linear, rectangular, and the like. Each finishing weld 312 may have the same dimension 326 as the tack welds 310.

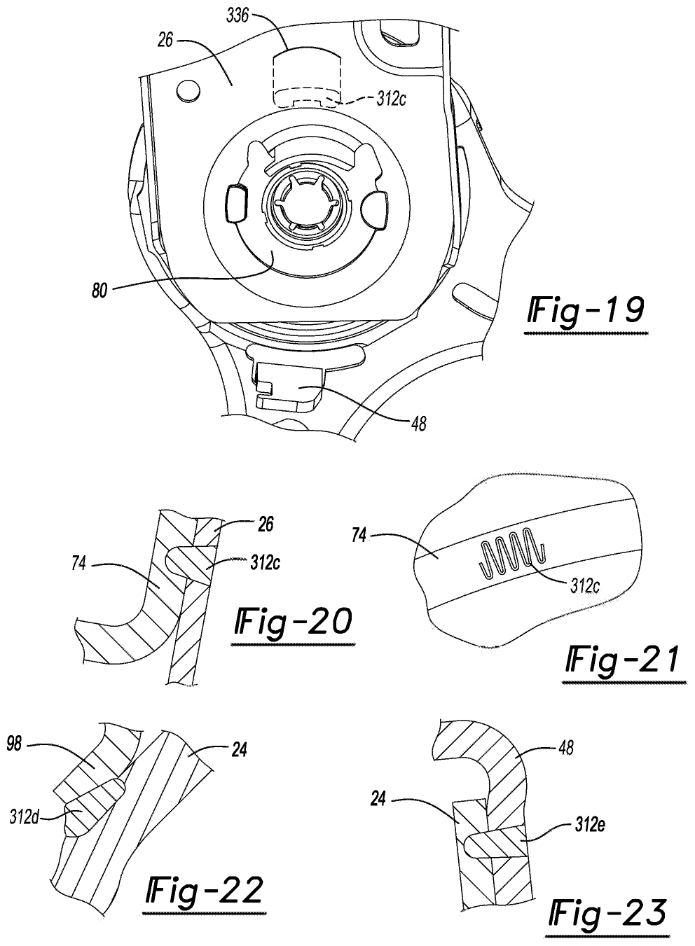

The finishing weld 312 as a continuous finishing weld may be formed in a variety of shapes. The shape of the finishing weld 312 may be dependent upon the shape of the first and second recliner components 314, 316 and the available surface area to be welded. For example, the finishing weld 312 may be formed in a complete ring shape, an arc shape, a rectangular shape, or the like. The finishing weld 312 may define a dimension 336 (see FIG. 19), such as a length or arc length, that is dependent on the finishing weld shape, part size, part shape and complexity.

In at least some example embodiments, the method further includes directing a fluid toward a region of the weld. The fluid may be air. The fluid may facilitate cooling of the first and second recliner components 314, 316 and/or a reduction or removal of smoke from the region.

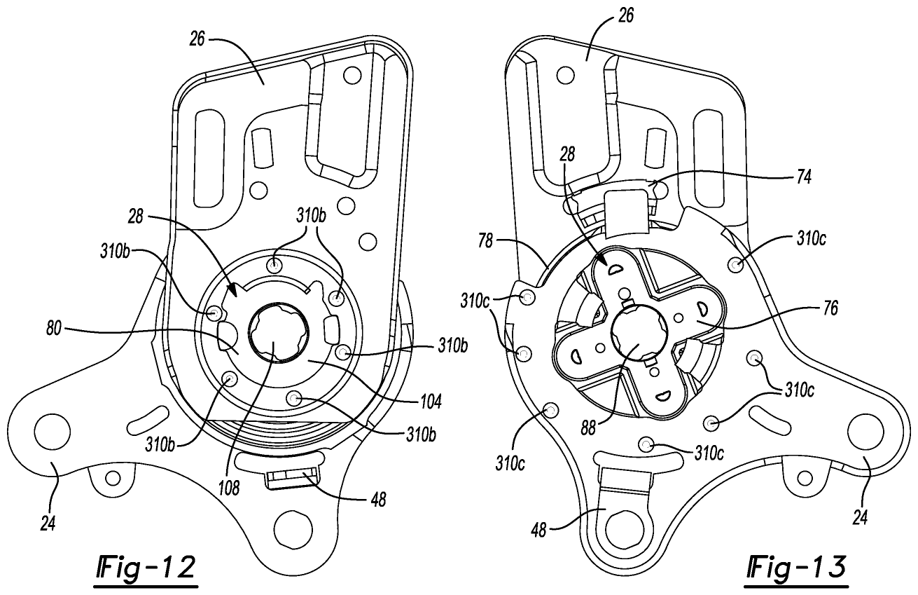

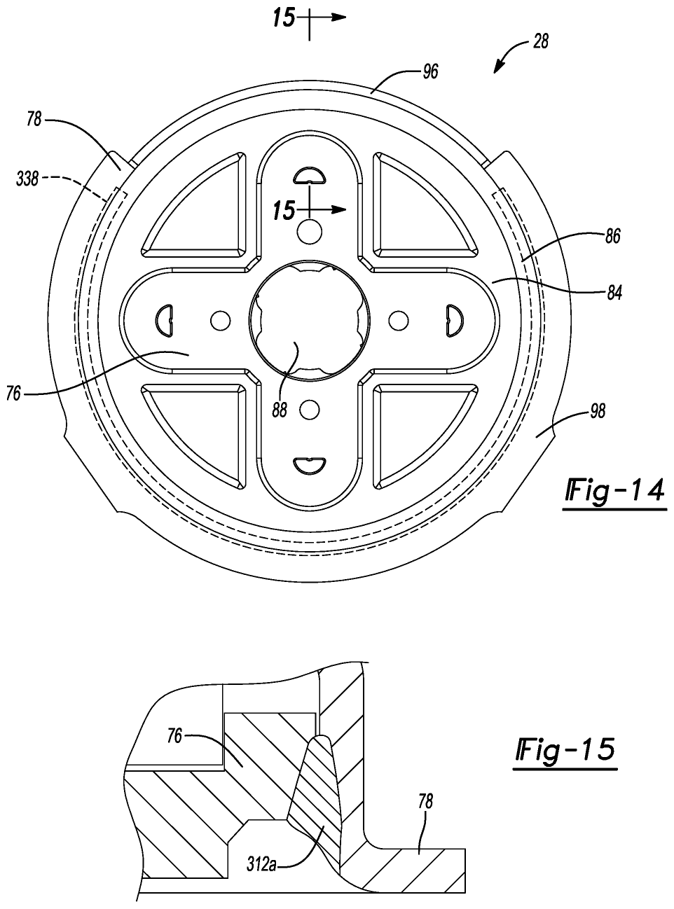

In at least some example embodiments, one or more finishing welds are formed between two portions or components of the recliner heart 28 of FIGS. 1-7. FIGS. 14-15 depict a plurality of finishing welds 312a (which may be the same as finishing weld 312 of FIGS. 9A-9B) between the encapsulating ring 78 and the first plate 76 of the recliner heart 28 according to the principles of the present disclosure. More specifically, a finishing weld region 338 is provided and represents a region where the finishing weld 312a may be positioned. The finishing weld region 338 extends at least between the body 96 of the encapsulating ring 78 and the rim 86 of the first plate 76. Some finishing weld regions 338 may extend between the first flange 98 of the encapsulating ring 78 and the rim 86 of the first plate 76. Accordingly, the finishing weld 312a is positioned between the encapsulating ring 78 and the first plate 76. The shown configuration provides the finishing weld region 338 and the finishing weld 312a formed in an arc-shape and extending for about the length of the first flange 98 of the encapsulating ring 78. However, the shape and dimension of the finishing weld 312c may vary. The finishing welds 312a may be rim welds, as depicted, or alternatively lap welds.

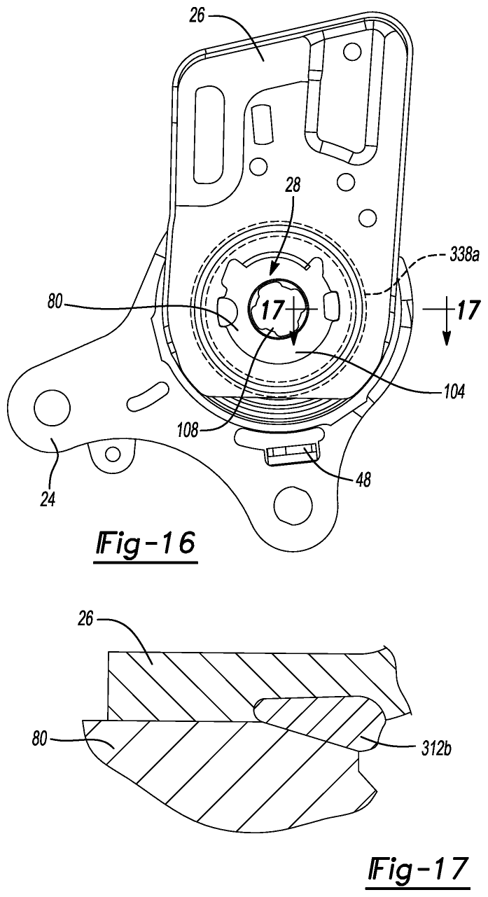

In at least some example embodiments, one or more finishing welds are formed between the second bracket plate 26 and the recliner heart 28 of FIGS. 1-7. FIGS. 16-17 depicts a finishing weld 312b (which may be the same as finishing weld 312 of FIGS. 9A-9B) between the second bracket plate 26 and the second plate 80 of the recliner heart 28. More specifically, a finishing weld region 338a is provided. The finishing weld region 338a represents a region where the finishing weld 312b may be positioned. The finishing weld region 338a extends at least between the second bracket plate 26 and the plate surface 104 of the second plate 80. The shown configuration provides the finishing weld region 338a and the finishing weld 312b extending annularly about the aperture 108. However, the shape and dimension of the finishing weld 312c may vary. The finishing welds 312b may be in the form of rim welds, as depicted, or alternatively lap welds.

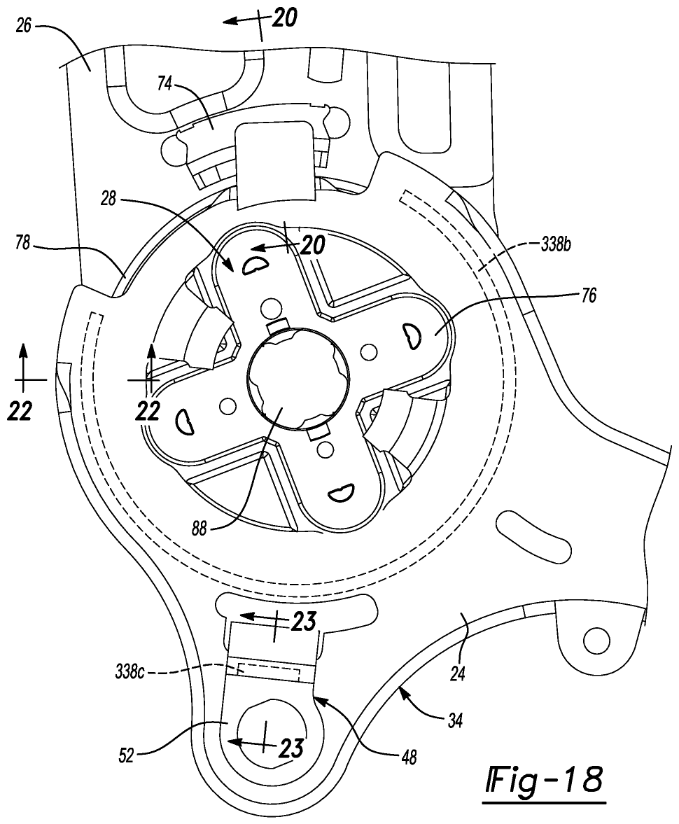

In at least some example embodiments, one or more finishing welds are formed between the second bracket plate 26 and the stop bracket 74 of FIGS. 1-7. FIGS. 18-21 depict a finishing weld 312c (which may be the same as finishing weld 312 of FIGS. 9A-9B) between the second bracket plate 26 and the stop bracket 74. More specifically, the finishing weld 312c extends fully through the second bracket plate 26 and partially through the stop bracket 74. In the shown embodiment, the finishing weld 312c is formed in substantially an arc-shape having an arc length as the dimension 336. However, the shape and dimension of the finishing weld 312c may vary. The finishing weld 312c may be in the form of a lap weld, as depicted, or alternatively a rim weld. Additionally, the weld path is illustrated in a sine-wave shaped path, however, the weld path may be an alternative path such as an overlapping path.

In at least some example embodiments, one or more finishing welds are formed between the first bracket plate 24 and the recliner heart 28 of FIGS. 1-7. FIGS. 18 and 22 depict a finishing weld 312d (which may be the same as finishing weld 312 of FIGS. 9A-9B) between the first bracket plate 24 and the encapsulating ring 78 of the recliner heart 28. A finishing weld region 338b is provided and represents a region where the finishing weld 312 may be positioned. The finishing weld 312d is formed in an arc-shape and extends for about the length of the first flange 98 of the encapsulating ring 78. The finishing weld 312d may be in the form of a rim weld, as depicted, or alternatively, a lap weld.

In at least some example embodiments, one or more finishing welds are formed between the first bracket plate 24 and the tab 48. FIGS. 18 and 23 depict a finishing weld 312e (which may be the same as finishing weld 312 of FIGS. 9A-9B) between the first bracket plate 24 and the tab 48. A finishing weld region 338c is provided and represents a region where the finishing weld 312e may be positioned. The finishing weld 312e extends fully through the second member 52 of the tab 48 and partially through the first portion 34 of the first bracket plate 24. The finishing weld 312e may be in the form of a lap weld, as depicted, or alternatively a rim weld.

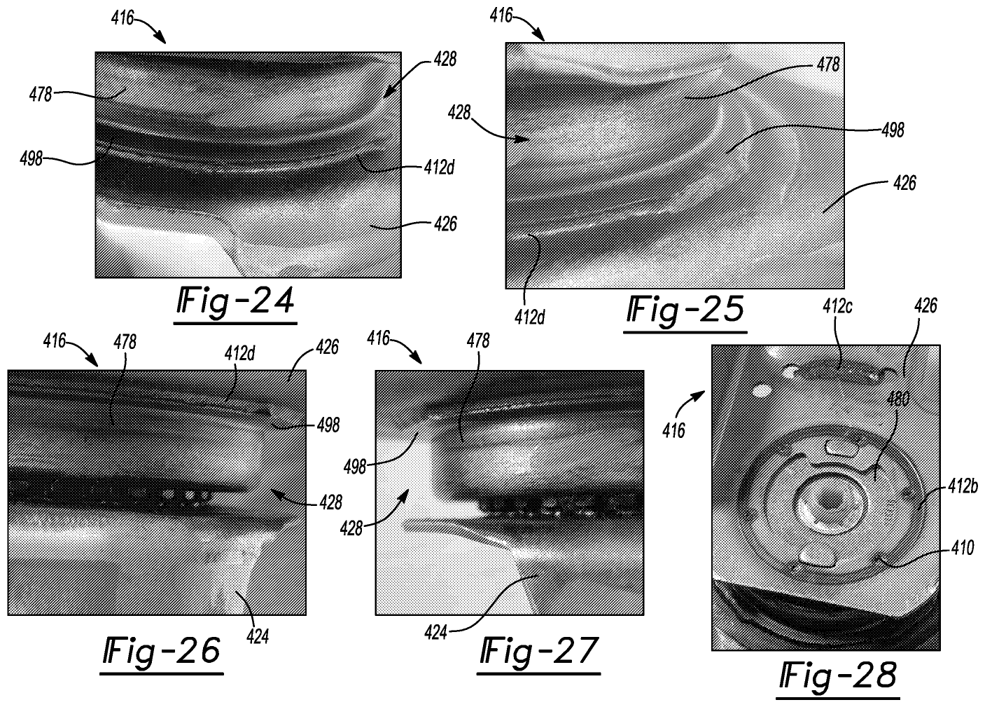

With reference to FIGS. 24-28, a seat recliner assembly 416 is prepared according to the present disclosure. The seat recliner assembly 416 is the same as the seat recliner assembly 16. Accordingly, the seat recliner assembly 416 includes a first bracket plate 424, a second bracket plate 426, a recliner heart 428 and a stop bracket (not shown). The recliner heart 428 includes a first plate (not shown), an encapsulating ring 478 having a second plate 480, and a first flange 498. In FIGS. 24-27, the first bracket plate 424 and recliner heart 428 are coupled by a plurality of tack welds (not shown) and a finishing weld 412d (which is the same as finishing weld 312d of FIG. 22). More specifically, the finishing weld 412d is provided annularly about the first flange 498 of the encapsulating ring 478. In FIG. 28, the second bracket plate 426 is coupled to the stop bracket by a tack weld (not shown) and a finishing weld 412c (which is the same as finishing weld 312c of FIG. 19). The finishing weld 412c is substantially formed in the shape of an arc and attaches the second bracket plate 426 and the stop bracket. In FIG. 28, the second bracket plate 426 is also coupled to the recliner heart 428 by a plurality of tack welds 410 (which is the same as tack weld 310b of FIG. 12). and a finishing weld 412b (which is the same as finishing weld 312b of FIG. 17). The plurality of tack welds 410 are annularly spaced and attach the second bracket plate 426 and the second plate 480 of the recliner heart 428.

Although the example embodiments described and shown related to a vehicle recliner mechanism, the methods herein are suitable for other processes involving laser welded or gas metal arc welding. Some example embodiments relate to methods of manufacturing other vehicle components, such as seat track assemblies.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of laser welding a recliner assembly comprising:
positioning a first component of a vehicle seat recliner mechanism with respect to a second component of the vehicle seat recliner mechanism;
retaining a position of the first component and the second component by forming a plurality of tack welds between the first component and the second component; and
fixing the first component to the second component, the fixing including forming a finishing weld between the first component and the second component by laser welding the first component to the second component.

2. The method of claim 1, wherein the first component and the second component are selected from the group consisting of: an upper bracket plate, a lower bracket plate, a recliner heart, an encapsulating ring, a gear plate, a guide plate, a spring bracket, a stop bracket, or any combination thereof.

3. The method of claim 2, wherein the first component includes the upper bracket plate, and the second component includes the recliner heart.

4. The method of claim 2, wherein the first component includes the lower bracket plate, and the second component includes the recliner heart.

5. The method of claim 2, wherein the first component includes the guide plate, and the second component includes the encapsulating ring.

6. The method of claim 1, further comprising:
clamping the first component and the second component to a fixture before the retaining, and
unclamping the first component and the second component from the fixture before the fixing.

7. The method of claim 1, further comprising:
cooling a region including at least a portion of the finishing weld by directing a fluid at the region, the cooling being performed concurrently with the fixing.

8. The method of claim 1, wherein:
the positioning and the retaining are performed at a first location,
the fixing is performed at a second location, and
the method further comprises moving the first component and the second component from the first location to the second location after the retaining.

9. The method of claim 1, wherein the positioning, the retaining, and the fixing are performed at the same location.

10. The method of claim 1, wherein the plurality of tack welds includes substantially equally spaced apart tack welds or substantially unequally spaced apart tack welds.

11. The method of claim 1, wherein the tack welds includes rim welds, lap welds or both rim and lap welds.

12. The method of claim 1, wherein the finishing weld includes a rim weld, a lap weld, or both rim and lap welds.

13. The method of claim 1, wherein the forming the plurality of tack welds includes laser welding.

14. The method of claim 1, wherein the forming the tack welds generates less heat than forming the finishing weld.

15. The method of claim 1, wherein the forming the tack welds uses a lower power than forming the finishing weld.

16. The method of claim 1, wherein forming the tack welds includes applying power for about 0.5 seconds per tack weld.

17. The method of claim 1, wherein the forming the plurality of tack welds and forming the finishing weld is at a speed ranging from about 2 m/min to about 10 m/min.

18. The method of claim 1, wherein the tack welds and finishing welds have a depth of fusion ranging from about 0.25 mm to about 3 mm and a width of fusion ranging from about 0.5 mm to 4.5 mm.

19. A method of laser welding a recliner assembly comprising:
positioning a first component of a vehicle seat recliner mechanism with respect to a second component of the vehicle seat recliner mechanism;
clamping the first component and the second component to a fixture;
retaining a position of the first component and the second component by forming a plurality of tack welds between the first component and the second component;
unclamping the first component and the second component from the fixture;
moving the first component and the second component from a first location to a second location; and
fixing the first component to the second component, the fixing including forming a finishing weld between the first component and the second component by laser welding the first component to the second component.

20. The method of claim 19, wherein the first component and the second component are selected from the group consisting of: an upper bracket plate, a lower bracket plate, a recliner heart, an encapsulating ring, a gear plate, a guide plate, a spring bracket, a stop bracket, or any combination thereof.
